(19) United States
(12) Patent Application Publication
(10) Pub. No.: US 2025/0075065 A1
(43) Pub. Date: Mar. 6, 2025

(54) THERMOPLASTIC ELASTOMER MOLDED ARTICLE, COMPOSITE MOLDED ARTICLE, AND PRODUCTION METHOD

(71) Applicant: SUMITOMO CHEMICAL COMPANY, LIMITED, Tokyo (JP)

(72) Inventor: Katsuya KIDA, Chiba (JP)

(21) Appl. No.: 18/817,734

(22) Filed: Aug. 28, 2024

(30) Foreign Application Priority Data
Aug. 31, 2023 (JP) 2023-141201

(51) Int. Cl. C08L 23/16; C08J 3/20; C08K 5/20; C08L 91/00

(52) U.S. Cl. CPC C08L 23/16; C08J 3/201; C08K 5/20; C08L 91/00; C08J 2323/16; C08J 2391/00; C08J 2423/12; C08J 2423/16; C08J 2453/02; C08L 2203/30; C08L 2205/025; C08L 2205/03; C08L 2205/06; C08L 2312/00

(57) ABSTRACT

A molded article includes at least one of the following: an ethylene-based copolymer (A), a copolymer (B) derived from an aromatic vinyl compound and a conjugated diene compound, a propylene-based polymer (C), and a lubricant (D). The article has a flexural modulus of 20-300 MPa at room temperature, measured per JIS K7171. It also has a shear strength of 40 N/cm² or less, determined by placing two test pieces (50 mm×6 mm×2 mm) from the article onto a flat plate, contacting them with a float glass plate (110 mm×110 mm×3 mm) as per JIS R 3202, and applying tension at 200 mm/min after conditioning at 80° C. for 50 hours.

### BACKGROUND OF THE INVENTION

### Field of the Invention

The present invention relates to a thermoplastic elastomer molded article.

### Description of the Related Art

A thermoplastic elastomer molded article is highly recyclable and appropriately formed by injection molding, and has excellent product performance such as strength and flexibility, and the thermoplastic elastomer molded article is therefore widely used as a material of, for example, vehicle components including a glass run channel (see, for example, WO 2021/193554 A1).

Along with expansion of uses of the thermoplastic elastomer molded article, further improvement of various types of performance has been required such as suppression of a sound made when the thermoplastic elastomer molded article is peeled from glass, and bondability to other members.

### SUMMARY OF THE INVENTION

Under these circumstances, the present invention aims at providing a thermoplastic elastomer molded article that can effectively suppress a sound made when peeled from glass, and that has excellent bondability to other members.

The inventor of the present invention has conducted an earnest study in view of such a background and completed the present invention.

That is, the present invention relates to

[1]
a molded article containing: at least one component selected from the group consisting of an ethylene-based copolymer (A) and a copolymer (B) having a structural unit derived from an aromatic vinyl compound and a structural unit derived from a conjugated diene compound; a propylene-based polymer (C); and a lubricant (D),
the molded article having a flexural modulus measured at room temperature in accordance with JIS K7171 of 20 MPa or more and 300 MPa or less, and
the molded article having a shear strength of 40 N/cm² or less, the shear strength being measured by disposing, on a flat plate, two test pieces cut out from the molded article and having a length of 50 mm, a width of 6 mm, and a thickness of 2 mm, such that a gap between opposite 50 mm×2 mm surfaces of the two test pieces is 60 mm, fixing 50 mm×6 mm surfaces of the two test pieces onto the flat plate, bringing other 50 mm×6 mm surfaces of the two test pieces into direct contact with a 110 mm×110 mm surface of a float glass plate having a length of 110 mm, a width of 110 mm, and a thickness of 3 mm in accordance with JIS R 3202, leaving the two test pieces and the float glass plate to stand still at 80° C. for 50 hours, and then subjecting an interlayer between the two test pieces and the float glass plate to tension at 200 mm/min in a shear direction and a longitudinal direction of the two test pieces.

The following [2] to [14] are each a preferred aspect or embodiment of the present invention.

[2]

The molded article according to [1], containing the ethylene-based copolymer (A).

[3]

The molded article according to [2], further containing a mineral oil (E).

[4]

The molded article according to [3], wherein the ethylene-based copolymer (A) is extended with the mineral oil (E).

[5]

The molded article according to [1], containing the copolymer (B) having a structural unit derived from an aromatic vinyl compound and a structural unit derived from a conjugated diene compound.

[6]

The molded article according to [5], further containing a mineral oil (E).

[7]

The molded article according to any one of [1] to [6], wherein the lubricant (D) contains at least a mono-fatty acid amide (D1) and a bis-fatty acid amide (D2), and a mass ratio mono-fatty acid amide (D1)/bis-fatty acid amide (D2) is in a range of 0.2 to 5.

[8]

The molded article according to [7], wherein the mass ratio mono-fatty acid amide (D1)/bis-fatty acid amide (D2) is in a range of 0.2 to 1.

[9]

The molded article according to [7] or [8], wherein the mono-fatty acid amide (D1) is erucamide.

[10]

The molded article according to any one of [7] to [9], wherein the bis-fatty acid amide (D2) is ethylene bisstearamide.

[11]

A method for producing the molded article according to any one of [1] to [10], the method including: a step of melt-kneading, in the presence of a crosslinker (F), a mixture containing: the at least one component selected from the group consisting of the ethylene-based copolymer (A) and the copolymer (B) having a structural unit derived from an aromatic vinyl compound and a structural unit derived from a conjugated diene compound; the propylene-based polymer (C); and the lubricant (D).

[12]

The molded article according to any one of [1] to [10], being an injection-molded article.

[13]

A composite molded article obtained by bonding the injection-molded article according to [12] to an extrusion-molded article containing a thermoplastic elastomer composition or a vulcanized rubber composition.

[14]

The composite molded article according to [13], being a glass run channel.

The present invention can provide a molded article that can effectively suppress a sound made when peeled from glass, and that has excellent bondability to other members.

### BRIEF DESCRIPTION OF THE DRAWING

FIG. 1 is a schematic diagram illustrating a method for measuring the shear strength against glass in one example of the present invention.

### DETAILED DESCRIPTION OF THE PREFERRED EMBODIMENTS

The present invention is a molded article containing: at least one component selected from the group consisting of an ethylene-based copolymer (A) and a copolymer (B) having a structural unit derived from an aromatic vinyl compound and a structural unit derived from a conjugated diene compound; a propylene-based polymer (C); and a lubricant (D),
the molded article having a flexural modulus measured at room temperature in accordance with JIS K7171 of 20 MPa or more and 300 MPa or less, and
the molded article having a shear strength of 40 N/cm² or less, the shear strength being measured by disposing, on a flat plate, two test pieces cut out from the molded article and having a length of 50 mm, a width of 6 mm, and a thickness of 2 mm, such that a gap between opposite 50 mm×2 mm surfaces of the two test pieces is 60 mm, fixing 50 mm×6 mm surfaces of the two test pieces onto the flat plate, bringing other 50 mm×6 mm surfaces of the two test pieces into direct contact with a 110 mm×110 mm surface of a float glass plate having a length of 110 mm, a width of 110 mm, and a thickness of 3 mm in accordance with JIS R 3202, leaving the two test pieces and the float glass plate to stand still at 80° C. for 50 hours, and then subjecting an interlayer between the two test pieces and the float glass plate to tension at 200 mm/min in a shear direction and a longitudinal direction of the two test pieces.

That is, the molded article according to the present invention is a molded article containing: the at least one component selected from the group consisting of the components (A) and (B); the component (C); and the component (D), the molded article having a flexural modulus in the specific numerical range, and having a shear strength against glass in the specific numerical range, with the shear strength measured under specific conditions.

By containing the at least one component selected from the group consisting of the components (A) and (B); the component (C); and the component (D), the molded article according to the present invention can contain a thermoplastic elastomer composition, and thereby have, for example, post-molding rubber elasticity, and moldability derived from thermoplasticity.

### Ethylene-Based Copolymer (A)

The ethylene-based copolymer (A) constituting the molded article according to the present invention is an ethylene copolymer containing 50 mass % or more and 99 mass % or less of a constitutional unit derived from ethylene, and a constitutional unit derived from at least one monomer selected from the group consisting of α-olefins having 3 or more and 10 or less carbon atoms (the total amount of the ethylene copolymer is defined as 100 mass %). The ethylene copolymer contains 50 mass % or more of a constitutional unit derived from ethylene, and is therefore a crosslinkable polymer and is appropriate for constituting, by dynamic crosslinking, an island phase of a sea-island structure of the thermoplastic elastomer composition.

The ethylene-based copolymer (A) is preferably a random copolymer.

The ethylene-based copolymer (A) may have a constitutional unit derived from a monomer other than the ethylene and the at least one selected from the group consisting of α-olefins having 3 or more and 10 or less carbon atoms.

Examples of the α-olefins having 3 or more and 10 or less carbon atoms include propylene, 1-butene, 2-methylpropene, 1-pentene, 3-methyl-1-butene, 1-hexene, 4-methyl-1-pentene, and 1-octene. In the preparation of the ethylene-based copolymer (A), the α-olefins having 3 or more and 10 or less carbon atoms may be used singly or in combination of two or more thereof. More preferred examples of the constitutional unit derived from at least one selected from the group consisting of α-olefins having 3 or more and 10 or less carbon atoms include a constitutional unit derived from propylene, a constitutional unit derived from 1-butene, and a constitutional unit derived from 1-octene.

The ethylene-based copolymer (A) has a proportion of the constitutional unit derived from ethylene of 50 mass % or more and 99 mass % or less, preferably 55 mass % or more and 90 mass % or less, more preferably 60 mass % or more and 85 mass % or less (the total amount of the ethylene-based copolymer (A) is defined as 100 mass %). The ethylene-based copolymer (A) has a proportion of the constitutional unit derived from at least one selected from the group consisting of α-olefins having 3 or more and 10 or less carbon atoms of 1 mass % or more and 50 mass % or less, preferably 10 mass % or more and 45 mass % or less, more preferably 15 mass % or more and 40 mass % or less (the total amount of the ethylene-based copolymer (A) is defined as 100 mass %).

The proportion of the constitutional unit derived from ethylene and the proportion of the constitutional unit derived from at least one monomer selected from the group consisting of α-olefins having 3 or more and 10 or less carbon atoms in the ethylene-based copolymer (A) can be determined by infrared spectroscopy. Specifically, an infrared absorption spectrum of the ethylene-based copolymer (A) is measured using an infrared spectrophotometer, and the proportion of the constitutional unit derived from ethylene and the proportion of the constitutional unit derived from at least one monomer selected from the group consisting of α-olefins having 3 or more and 10 or less carbon atoms can be calculated in accordance with a method described in “Characterization of Polyethylene by Infrared Absorption Spectrum (Takayama, Usami, et al.)” or “Die Makromolekulare Chemie, 177, 461 (1976) (McRae, M. A., MadamS, W. F., et al.)”. The proportion of the constitutional unit derived from ethylene and the proportion of the constitutional unit derived from at least one monomer selected from the group consisting of α-olefins having 3 or more and 10 or less carbon atoms in a component (A-1) and a component (A-2) described later can be determined in the same manner.

The ethylene-based copolymer (A) may have a constitutional unit derived from a monomer other than the ethylene and the at least one selected from the group consisting of α-olefins having 3 or more and 10 or less carbon atoms. Examples of the other monomer include: conjugated dienes having 4 or more and 8 or less carbon atoms, such as 1,3-butadiene, 2-methyl-1,3-butadiene, 1,3-pentadiene, and 2,3-dimethyl-1,3-butadiene; non-conjugated dienes having 5 or more and 15 or less carbon atoms, such as dicyclopentadiene, 5-ethylidene-2-norbornene, 1,4-hexadiene, 1,5-dicyclooctadiene, 7-methyl-1,6-octadiene, and 5-vinyl-2-norbornene; vinyl carboxylate esters such as vinyl acetate; unsaturated carboxylate esters such as methyl acrylate, ethyl acrylate, butyl acrylate, methyl methacrylate, and ethyl methacrylate; and unsaturated carboxylic acids such as acrylic acid and methacrylic acid. The other monomer is preferably a non-conjugated diene having 5 or more and 15 or less carbon atoms, more preferably 5-ethylidene-2-norbornene or dicyclopentadiene. The ethylene-based copolymer (A) may have two or more constitutional units derived from the other monomers.

When having the constitutional unit derived from a monomer other than the ethylene and the at least one selected from the group consisting of α-olefins having 3 or more and 10 or less carbon atoms, the ethylene-based copolymer (A) has a proportion of the constitutional unit derived from the other monomer of preferably 30 mass % or less, more preferably 20 mass % or less (the total amount of the ethylene-based copolymer (A) is defined as 100 mass %). The proportion of the constitutional unit derived from the other monomer can be determined by infrared spectroscopy. Specifically, the peak intensity of a peak derived from the other monomer of the ethylene-based copolymer (A) is measured using an infrared spectrophotometer, and the proportion of the constitutional unit derived from the other monomer in the ethylene-based copolymer (A) is calculated from the peak intensity. The proportion of the constitutional unit derived from the other monomer in the components (A-1) and (A-2) described later can be determined in the same manner.

Examples of the ethylene-based copolymer (A) include an ethylene-propylene copolymer, an ethylene-1-butene copolymer, an ethylene-1-hexene copolymer, an ethylene-1-octene copolymer, an ethylene-propylene-1-butene copolymer, an ethylene-propylene-1-hexene copolymer, an ethylene-propylene-1-octene copolymer, an ethylene-propylene-5-ethylidene-2-norbornene copolymer, an ethylene-propylene-dicyclopentadiene copolymer, an ethylene-propylene-1,4-hexadiene copolymer, and an ethylene-propylene-5-vinyl-2-norbornene copolymer. The ethylene-based copolymer (A) may also be an olefin-based block copolymer containing an ethylene polymerization block and an ethylene-α-olefin copolymerization block. As the component (A), the ethylene-based copolymers may be used singly or in combination of two or more thereof. As the component (A), an ethylene-propylene copolymer or an ethylene-propylene-5-ethylidene-2-norbornene copolymer can preferably be used.

Preferred examples of the ethylene-based copolymer (A) include the following ethylene random copolymer (A-1) and ethylene random copolymer (A-2).

The ethylene random copolymer (A-1) (hereinafter, sometimes referred to as a component (A-1)) is an ethylene random copolymer that contains 50 mass % or more and 90 mass % or less of a constitutional unit derived from ethylene, and a constitutional unit derived from at least one monomer selected from the group consisting of α-olefins having 3 or more and 10 or less carbon atoms, and that has a gel fraction of more than 10 mass % (the total amount of the ethylene random copolymer is defined as 100 mass %). The component (A-1) may have a constitutional unit derived from a monomer other than the ethylene and the at least one selected from the group consisting of α-olefins having 3 or more and 10 or less carbon atoms. Specific examples of the α-olefins having 3 or more and 10 or less carbon atoms in the component (A-1), a preferred range of the proportion of the constitutional unit derived from ethylene in the component (A-1), a preferred range of the proportion of the structural unit derived from at least one selected from the group consisting of α-olefins having 3 or more and 10 or less carbon atoms, specific examples of the constitutional unit derived from a monomer other than the ethylene and the at least one selected from the group consisting of α-olefins having 3 or more and 10 or less carbon atoms, a preferred range of the proportion of the other monomer, and specific examples of the ethylene random copolymer are the same as those of the ethylene-based copolymer (A).

The ethylene random copolymer having more crosslinking structures has a higher gel fraction.

The component (A-1) can be obtained by crosslinking the component (A-2) described later. The gel fraction of the component (A-1) can be determined by the following method using the following gel mass of a molded article containing the component (A-1) and the mass of the component (A-2) contained in a raw material of the molded article.

The gel fraction of the component (A-1) can be determined by the method described below, using a Soxhlet extractor including a reflux condenser, an extraction tube connected to a lower part of the reflux condenser, and a flask connected to a lower part of the extraction tube. A molded article (about 1 g) and an empty mesh basket made of wire (mesh size: 400 mesh) are each weighed. The molded article is sealed in the mesh basket and introduced into the extraction tube. Into the flask, o-xylene (300 ml) is introduced. The flask is heated to reflux the o-xylene for 24 hours for extraction. After the extraction, the mesh basket including an extraction residue therein is taken out from the test tube, and dried by a vacuum dryer at 100° C. under reduced pressure, and the dried mesh basket including an extraction residue therein is weighed. The gel mass of the molded article is calculated from the difference in mass between the dried mesh basket including an extraction residue therein and the empty mesh basket. The gel fraction (mass %) of the component (A-1) is calculated on the basis of the following equation.

Gel fraction of component (A-1)=(Gel mass of molded article/Mass of component (A-2))×100

The component (A-1) has a gel fraction of preferably 20 mass % or more, more preferably 40 mass % or more.

The more crosslinking structures the ethylene random copolymer has, the higher gel fraction the molded article has.

The gel fraction of a molded article can be calculated by the following equation, using the gel mass of the molded article determined by the same method as described above.

Gel fraction of molded article=(Gel mass of molded article/Mass of molded article)×100

The molded article has a gel fraction of preferably 10 mass % or more and 90 mass % or less, more preferably 15 mass % or more and 60 mass % or less, further preferably 18 mass % or more and 40 mass % or less.

The component (A-1) can be obtained by crosslinking the component (A-2) described later. Examples of a crosslinking method include a method for melt-kneading a composition containing the component (A-2) and a crosslinker (F) described later. The crosslinking may be performed simultaneously with the production of the molded article according to the present invention. In that case, a composition containing the component (A-2), a propylene-based polymer (C) described later, and the crosslinker (F) is melt-kneaded to produce a composition containing the component (A-1) and the propylene-based polymer (C). The detail is as described later.

The ethylene random copolymer (A-2) (hereinafter, sometimes referred to as a component (A-2)) is an ethylene random copolymer that contains 50 mass % or more and 90 mass % or less of a constitutional unit derived from ethylene, and a constitutional unit derived from at least one monomer selected from the group consisting of α-olefins having 3 or more and 10 or less carbon atoms, and that has a gel fraction of 10 mass % or less (the total amount of the ethylene random copolymer is defined as 100 mass %). The component (A-2) may have a constitutional unit derived from a monomer other than the ethylene and the at least one selected from the group consisting of α-olefins having 3 or more and 10 or less carbon atoms. Specific examples of the α-olefins having 3 or more and 10 or less carbon atoms in the component (A-2), a preferred range of the proportion of the constitutional unit derived from ethylene in the component (A-2), a preferred range of the proportion of the constitutional unit derived from at least one selected from the group consisting of α-olefins having 3 or more and 10 or less carbon atoms, specific examples of the constitutional unit derived from a monomer other than the ethylene and the at least one selected from the group consisting of α-olefins having 3 or more and 10 or less carbon atoms, a preferred range of the proportion of the other monomer, and specific examples of the ethylene random copolymer are the same as those of the ethylene-based copolymer (A).

The component (A-2) has a gel fraction of preferably 5 mass % or less, more preferably 0 mass %. The component (A-2) preferably has substantially no crosslinking structure.

The component (A-2) has a Mooney viscosity measured at 125° C. (ML₁₊₄125° C.) of preferably 5 or more and 350 or less, more preferably 10 or more and 300 or less, further preferably 40 or more and 250 or less. The Mooney viscosity (ML₁₊₄125° C.) is measured in accordance with JIS K6300 and the meaning of “ML₁₊₄125° C.” is as follows.
M: Mooney viscosity
L: Use of large rotor
125° C.: Measurement temperature
1+4: Measured value obtained when a sample is heated for 1 minute and then rotated with a rotor at 2 rpm for 4 minutes

Examples of a method for producing the component (A-2) include a method for copolymerizing, in the presence of a Ziegler-Natta catalyst or a known complex-based catalyst such as a metallocene complex and a non-metallocene complex, ethylene and at least one monomer selected from the group consisting of α-olefins having 3 or more and 10 or less carbon atoms. Examples of a polymerization method include a slurry polymerization method, a solution polymerization method, a bulk polymerization method, and a vapor phase polymerization method.

### Ethylene-α-Olefin-Non-Conjugated Diene Copolymer (A1)

An ethylene-α-olefin-non-conjugated diene copolymer (A1) preferably used as the ethylene-based copolymer (A) has a proportion of the non-conjugated diene unit of preferably 4 wt % to 15 wt %, more preferably 6 wt % to 15 wt %. The ethylene-α-olefin-non-conjugated diene copolymer (A1) according to the present embodiment is an ethylene-α-olefin-non-conjugated diene copolymer rubber having a hardness A based on JIS K6253 of 85 or less.

The α-olefin is preferably an α-olefin having 3 to 20 carbon atoms, and examples of such an α-olefin include propylene, 1-butene, 2-methylpropylene, 1-pentene, 3-methyl-1-butene, 1-hexene, 4-methyl-1-pentene, and 1-octene; and a combination of two or more thereof. Among these examples, propylene or 1-butene is preferred and propylene is more preferred, from the viewpoint of accessibility.

Examples of the non-conjugated diene include: chain non-conjugated dienes such as 1,4-hexadiene, 1,6-octadiene, 2-methyl-1,5-hexadiene, 6-methyl-1,5-heptadiene, and 7-methyl-1,6-octadiene; cyclic non-conjugated dienes such as cyclohexadiene, dicyclopentadiene, methyltetrahydroindene, 5-vinylnorbornene, 5-ethylidene-2-norbornene, 5-methylene-2-norbornene, 5-isopropylidene-2-norbornene, and 6-chloromethyl-5-isopropenyl-2-norbornene; and trienes such as 2,3-diisopropylidene-5-norbornene, 2-ethylidene-3-isopropylidene-5-norbornene, 2-propenyl-2,2-norbornadiene, and 4-ethylidene-8-methyl-1,7-nanodiene. Among these examples, 5-ethylidene-2-norbornene or dicyclopentadiene is preferred.

When the total of the ethylene unit, the α-olefin unit having 3 to 20 carbon atoms, and the non-conjugated diene unit contained in the ethylene-α-olefin-non-conjugated diene copolymer (A1) is defined as 100 mass %, the amount of the ethylene unit contained in the ethylene-α-olefin-non-conjugated diene copolymer (A1) is normally 30 mass % to 80 mass %, preferably 40 mass % to 80 mass %, and the amount of the α-olefin unit having 3 to 20 carbon atoms is normally 5 mass % to 50 mass %, preferably 15 mass % to 45 mass %. The amount of the non-conjugated diene unit contained in the ethylene-α-olefin-non-conjugated diene copolymer (A1) is 4 mass % to 15 mass %, preferably 6 mass % to 15 mass % (the total of these three constitutional units is defined as 100 mass %). Specific preferred examples of the ethylene-α-olefin-non-conjugated diene copolymer (A1) include an ethylene-propylene-5-ethylidene-2-norbornene copolymer, an ethylene-propylene-dicyclopentadiene copolymer, an ethylene-propylene-1,4-hexadiene copolymer, and an ethylene-propylene-5-vinyl-2-norbornene copolymer; and a combination of two or more thereof. Among these examples, preferred is an ethylene-propylene-5-ethylidene-2-norbornene copolymer having a proportion of the ethylene unit of 40 mass % to 80 mass %, a proportion of the propylene unit of 15 mass % to 45 mass %, and a proportion of the 5-ethylidene-2-norbornene unit of 4 mass % to 15 mass %.

The amounts of the ethylene unit, the α-olefin unit having 3 to 20 carbon atoms, and the non-conjugated diene unit contained in the ethylene-α-olefin-non-conjugated diene copolymer (A1) can be determined by infrared spectroscopy (IR method). Specifically, the ethylene-α-olefin-non-conjugated diene copolymer (A1) is molded into a film having a thickness of about 0.5 mm, next a peak (absorption peak at 1688 cm-1) derived from 5-ethylidene-2-norbornene of the film is measured using an infrared spectrophotometer, and the amount of the 5-ethylidene-2-norbornene unit in the copolymer is calculated. Next, the copolymer is molded into a film having a thickness of about 0.1 mm, an infrared absorption spectrum of the film is measured using an infrared spectrophotometer, the ratio between the ethylene unit and the propylene unit is determined in accordance with a method described in the document (Characterization of Polyethylene by Infrared Absorption Spectrum. Takayama, Usami, et al., or Die Makromolekulare Chemie. 177, 461 (1976). McRae, M. A., MadamS, W. F., et al.), and the amounts of the ethylene unit and the propylene unit can be calculated from the ratio and the amount of the 5-ethylidene-2-norbornene unit.

The ethylene-α-olefin-non-conjugated diene copolymer (A1) can be obtained through polymerization by a known method. Examples of a polymerization method include a method for performing polymerization in an inert solvent such as hexane, heptane, toluene, and xylene, using a polymerization catalyst such as a Ziegler-Natta catalyst and a metallocene catalyst.

The ethylene-α-olefin-non-conjugated diene copolymer (A1) has a Mooney viscosity (ML₁₊₄125° C.) of preferably 5 or more and 350 or less, more preferably 10 or more and 300 or less, further preferably 50 or more and 250 or less. An olefin-based thermoplastic elastomer composition obtained using the ethylene-α-olefin-non-conjugated diene copolymer (A1) having a Mooney viscosity in the above range can be molded into a molded product having excellent mechanical strength and very good appearance. The Mooney viscosity (ML₁₊₄125° C.) is measured in accordance with JIS K6300.

When the component (A1) and a mineral oil (hereinafter, sometimes referred to as a component (E)) are mixed in advance, the Mooney viscosity (ML₁₊₄125° C.) of the component (A1) can be calculated by the following equation (1).

log(ML1/ML2)=0.0066(ΔPHR) (1)
ML1: Mooney viscosity of component (A1)
ML2: Mooney viscosity of mixture of components (A1) and (E)
ΔPHR: Ratio of component (E) to 100 parts by weight of component (A1)

Copolymer (B) having structural unit derived from aromatic vinyl compound and structural unit derived from conjugated diene compound

Examples of the copolymer (B) having a structural unit derived from an aromatic vinyl compound and a structural unit derived from a conjugated diene compound include an aromatic vinyl compound-conjugated diene compound polymer, an aromatic vinyl compound-conjugated diene compound-aromatic vinyl compound polymer, and hydrogenated products thereof. Among these examples, a hydrogenated product of an aromatic vinyl compound-conjugated diene compound-aromatic vinyl compound polymer is preferred.

Examples of the aromatic vinyl compound in the component (B) include styrene, α-methylstyrene, o-, m-, or p-methylstyrene, 1,3-dimethylstyrene, vinylxylene, monochlorostyrene, dichlorostyrene, monobromostyrene, dibromostyrene, ethylstyrene, and vinylnaphthalene.

Examples of the conjugated diene compound in the component (B) include butadiene, isoprene, 2,3-dimethyl-1,3-butadiene, 2-neopentyl-1,3-butadiene, 2-chloro-1,3-butadiene, and 2-cyano-1,3-butadiene. Butadiene or isoprene is preferred.

The proportion of the structural unit derived from an aromatic vinyl compound is preferably 10 mass % or more and 50 mass % or less, more preferably 15 mass % or more and 45 mass % or less, further preferably 20 mass % or more and 40 mass % or less, in order to make the mold less likely to be stained at the time of molding a molded article, and make the molded article have good tensile characteristics and appearance. The above proportion is based on when the total amount of the copolymer having a structural unit derived from an aromatic vinyl compound and a structural unit derived from a conjugated diene compound is defined as 100 mass %. The proportion of the structural unit derived from an aromatic vinyl compound can be determined by 1H-NMR measurement.

The proportion of the structural unit derived from a conjugated diene compound is preferably 50 mass % or more and 90 mass % or less, more preferably 55 mass % or more and 85 mass % or less, further preferably 60 mass % or more and 80 mass % or less. The above proportion is based on when the total amount of the copolymer having a structural unit derived from an aromatic vinyl compound and a structural unit derived from a conjugated diene compound is defined as 100 mass %. The proportion of the structural unit derived from a conjugated diene compound can be determined by 1H-NMR measurement.

The component (B) may be a hydrogenated product. In that case, the hydrogenation rate is preferably 80% or more, more preferably 90% or more. The above proportion is molar-basis proportion based on when the amount of double bonds in the structural unit derived from a conjugated diene compound in the copolymer having not been hydrogenated is defined as 100%.

Examples of a method for producing the component (B) include a method described in JP-B-40-23798. Examples of a method for hydrogenating the copolymer having a structural unit derived from an aromatic vinyl compound and a structural unit derived from a conjugated diene compound include methods described in JP-B-42-8704, JP-B-43-6636, JP-A-59-133203, and JP-A-60-79005. As the copolymer having a structural unit derived from an aromatic vinyl compound and a structural unit derived from a conjugated diene compound, commercially available products may be used such as “KRATON-G” manufactured by Kraton Polymers LLC, “SEPTON” manufactured by Kuraray Co., Ltd., “Tuftec” manufactured by Asahi Kasei Corp., and “TAIPOL” manufactured by TSRC Corporation.

### Propylene-Based Polymer (C)

The molded article according to the present invention contains a propylene-based polymer (C).

The propylene-based polymer (C) (hereinafter, sometimes referred to as a component (C)) contained in the molded article according to the present invention is a propylene (co)polymer containing more than 50 mass % and 100 mass % or less of a constitutional unit derived from propylene. The component (C) may have a constitutional unit derived from a monomer other than the propylene.

The component (C) contains 50 mass % or more of a constitutional unit derived from propylene, and is therefore a non-crosslinkable or decomposable polymer compared to the components (A) and (B) and the like and is appropriate for constituting a sea phase of a sea-island structure of the thermoplastic elastomer composition suitable as a material for constituting the molded article according to the present invention.

Examples of the monomer other than the propylene include ethylene and an α-olefin having 4 or more carbon atoms, and preferred are ethylene and an α-olefin having 4 or more and 20 or less carbon atoms.

Examples of the α-olefin having 4 or more and 20 or less carbon atoms include 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 3-methyl-1-butene, 3-methyl-1-pentene, 4-methyl-1-pentene, 2-ethyl-1-hexene, and 2,2,4-trimethyl-1-pentene.

The proportion of the constitutional unit derived from propylene, the proportion of the constitutional unit derived from ethylene, and the proportion of the constitutional unit derived from at least one monomer selected from the group consisting of α-olefins having 4 or more carbon atoms in the propylene-based polymer (C) can be determined by the same method as used to determine the proportions of the constitutional units in the ethylene-based copolymer (A).

Examples of the propylene-based polymer (C) include a propylene homopolymer (C1), a propylene random copolymer, and a heterophasic propylene polymerization material (C2). The molded article according to the present invention may contain only one propylene-based polymer (C) or two or more propylene-based polymers (C).

Preferred examples of the propylene random copolymer include:
(1) a propylene-ethylene random copolymer having a proportion of the constitutional unit derived from propylene of 90 mass % or more and 99.5 mass % or less, and a proportion of the constitutional unit derived from ethylene of 0.5 mass % or more and 10 mass % or less (the total amount of the constitutional unit derived from propylene and the constitutional unit derived from ethylene is defined as 100 mass %);
(2) a propylene-ethylene-α-olefin random copolymer having a proportion of the constitutional unit derived from propylene of 81 mass % or more and 99 mass % or less, a proportion of the constitutional unit derived from ethylene of 0.5 mass % or more and 9.5 mass % or less, and a proportion of the constitutional unit derived from an α-olefin having 4 or more and 10 or less carbon atoms of 0.5 mass % or more and 9.5 mass % or less (the total amount of the constitutional unit derived from propylene, the constitutional unit derived from ethylene, and the constitutional unit derived from an α-olefin having 4 or more and 10 or less carbon atoms is defined as 100 mass %); and
(3) a propylene-α-olefin random copolymer having a proportion of the constitutional unit derived from propylene of 90 mass % or more and 99.5 mass % or less, and a proportion of the constitutional unit derived from an α-olefin having 4 or more and 10 or less carbon atoms of 0.5 mass % or more and 10 mass % or less (the total amount of the constitutional unit derived from propylene and the constitutional unit derived from an α-olefin having 4 or more and 10 or less carbon atoms is defined as 100 mass %).

Examples of the α-olefin having 4 or more and 10 or less carbon atoms in (1) and (2) include: linear α-olefins such as 1-butene, 1-pentene, 1-hexene, 1-octene, and 1-decene; and branched α-olefins such as 3-methyl-1-butene and 3-methyl-1-pentene. In the preparation of (1) and (2), the α-olefins having 4 or more and 10 or less carbon atoms may be used singly or in combination of two or more thereof.

Examples of a method for producing the propylene homopolymer (C1) and the propylene random copolymer include a method for polymerizing propylene (and anther monomer as necessary) in the presence of a Ziegler-Natta catalyst or a complex-based catalyst such as a metallocene complex and a non-metallocene complex. Examples of a polymerization method include a slurry polymerization method, a solution polymerization method, a bulk polymerization method, and a vapor phase polymerization method.

In the present specification, the term “heterophasic propylene polymerization material” means a mixture having a structure in which a copolymer (II) containing 20 mass % or more and 90 mass % or less of a constitutional unit derived from ethylene, and a constitutional unit derived from at least one monomer selected from the group consisting of α-olefins having 3 or more carbon atoms (the total mass of the copolymer is defined as 100 mass %) (hereinafter, sometimes simply referred to as a “copolymer (II)”) is dispersed in a matrix of a polymer (I) containing more than 80 mass % and 100 mass % or less of a constitutional unit derived from propylene (the total mass of the polymer is defined as 100 mass %) (hereinafter, sometimes simply referred to as a “polymer (I)”).

The heterophasic propylene polymerization material (C2) as the component (C) contains 50 mass % or more of the constitutional unit derived from propylene, with the total amount of the heterophasic propylene polymerization material defined as 100 mass %.

The amount of the polymer (I) contained in the heterophasic propylene polymerization material (C2) is preferably 70 mass % or more and 90 mass % or less, more preferably 75 mass % or more and 90 mass % or less (the total amount of the heterophasic propylene polymerization material (C2) is defined as 100 mass %). The amount of the copolymer (II) contained in the heterophasic propylene polymerization material (C2) is preferably 10 mass % or more and 30 mass % or less, more preferably 10 mass % or more and 25 mass % or less (the total amount of the heterophasic propylene polymerization material (C2) is defined as 100 mass %).

Examples of the α-olefin having 3 or more carbon atoms and contained in the copolymer (II) include propylene, 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 3-methyl-1-butene, 3-methyl-1-pentene, 4-methyl-1-pentene, 2-ethyl-1-hexene, and 2,2,4-trimethyl-1-pentene. The α-olefin having 3 or more carbon atoms is preferably an α-olefin having 3 or more and 20 or less carbon atoms, more preferably an α-olefin having 3 or more and 10 or less carbon atoms, further preferably propylene, 1-butene, 1-hexene, or 1-octene. In the copolymer (II), the α-olefins having 3 or more carbon atoms may be used singly or in combination of two or more thereof.

The copolymer (II) has a proportion of the constitutional unit derived from ethylene of preferably 22 mass % or more and 80 mass % or less, more preferably 25 mass % or more and 70 mass % or less, further preferably 27 mass % or more and 60 mass % or less (the total amount of the constitutional unit derived from at least one selected from the group consisting of α-olefins having 3 or more carbon atoms, and the constitutional unit derived from ethylene is defined as 100 mass %). The copolymer (II) has a proportion of the constitutional unit derived from at least one monomer selected from the group consisting of α-olefins having 3 or more carbon atoms of preferably 20 mass % or more and 78 mass % or less, more preferably 30 mass % or more and 75 mass % or less, further preferably 40 mass % or more and 73 mass % or less (the total amount of the constitutional unit derived from at least one monomer selected from the group consisting of α-olefins having 3 or more carbon atoms, and the constitutional unit derived from ethylene is defined as 100 mass %).

Examples of the copolymer (II) include a propylene-ethylene copolymer, an ethylene-1-butene copolymer, an ethylene-1-hexene copolymer, an ethylene-1-octene copolymer, a propylene-ethylene-1-butene copolymer, a propylene-ethylene-1-hexene copolymer, and a propylene-ethylene-1-octene copolymer. A propylene-ethylene copolymer or a propylene-ethylene-1-butene copolymer is preferred. The copolymer (II) is normally a random copolymer.

Examples of a method for producing the heterophasic propylene polymerization material (C2) as the component (C) include a method for subjecting a monomer containing propylene, and ethylene or the like to multistep polymerization in the presence of a polymerization catalyst. Examples of the multistep polymerization include a method for producing, in a first polymerization step, the polymer (I) by polymerizing a monomer containing propylene in the presence of a polymerization catalyst, and producing, in a second polymerization step, the copolymer (II) by copolymerizing, in the presence of the polymer (I) obtained in the first polymerization step, ethylene and at least one monomer selected from the group consisting of α-olefins having 3 or more carbon atoms. Examples of the polymerization catalyst used in the production of the heterophasic propylene polymerization material (C2) include a Ziegler catalyst, a Ziegler-Natta catalyst, a catalyst made from a cyclopentadienyl ring-containing compound of a transition metal in Group 4 of the periodic table and an alkylaluminoxane, and a catalyst made from a cyclopentadienyl ring-containing compound of a transition metal in Group 4 of the periodic table, a compound that reacts with the transition metal compound to form an ionic complex, and an organic aluminum compound. Further, a preliminary polymerization catalyst may also be used in the presence of the polymerization catalyst. Examples of the preliminary polymerization catalyst include catalysts described in JP-A-61-218606, JP-A-61-287904, JP-A-5-194685, JP-A-7-216017, JP-A-9-316147, JP-A-10-212319, and JP-A-2004-182981.

Examples of a polymerization method in the production of the heterophasic propylene polymerization material (C2) as the component (C) include bulk polymerization, solution polymerization, slurry polymerization, and vapor phase polymerization. Examples of an inert hydrocarbon solvent used in the solution polymerization and the slurry polymerization include propane, butane, isobutane, pentane, hexane, heptane, and octane. The polymerization may be performed by a combination of two or more of these polymerization methods, and may be batch polymerization or continuous polymerization. The polymerization method in the production of the heterophasic propylene polymerization material (C2) is preferably continuous vapor phase polymerization or bulk-vapor phase polymerization in which bulk polymerization and vapor phase polymerization are continuously performed.

From the viewpoint of, for example, bondability to other members, the propylene-based polymer (C) has a melt flow rate (MFR) of preferably 0.3 g/10 min or more and 200 g/10 min or less, the melt flow rate being measured under the conditions of a temperature of 230° C. and a load of 21.18 N in accordance with JIS K7210. The propylene-based polymer (C) has a melt flow rate of more preferably 2.5 g/10 min or more and 150 g/10 min or less, further preferably 10 g/10 min or more and 105 g/10 min or less.

The propylene-based polymer (C) includes a 20° C.-xylene-insoluble portion (hereinafter, described as a CXIS portion) having an intrinsic viscosity (hereinafter, described as [η_{cxis}]) of preferably 0.1 dl/g or more and 6.0 dl/g or less, more preferably 0.3 dl/g or more and 5.0 dl/g or less, further preferably 0.3 dl/g or more and 3.1 dl/g or less.

The intrinsic viscosity can be determined by the following procedure. The reduced viscosity is measured in 135° C. tetralin, using an Uberode viscometer, and the intrinsic viscosity is determined from the measured reduced viscosity by an extrapolation method in accordance with a calculation method described in “Polymer Solution, Polymer Experiment 11” (published by KYORITSU SHUPPAN CO., LTD., 1982), page 491.

Here, a CXS portion and the CXIS portion can be obtained by the following method. The propylene-based polymer (C) (about 5 g) is completely dissolved in boiling xylene (500 ml). The resultant xylene solution is gradually cooled to 20° C., has the state thereof adjusted at 20° C. for 4 hours or more, and is filtered into a precipitate and a solution. The precipitate is the CXIS portion. A product obtained by removing the solvent from the solution is the 20° C.-xylene-soluble portion (CXS portion).

The propylene-based polymer (C) is preferably the propylene homopolymer (C1), the propylene-ethylene random copolymer, the propylene-ethylene-1-butene random copolymer, or the heterophasic propylene polymerization material (C2), more preferably the propylene homopolymer (C1) or the heterophasic propylene polymerization material (C2), further preferably the propylene homopolymer (C1).

### Lubricant (D)

The lubricant (D) is not particularly limited, and various compounds that have been usable as conventional lubricants in this technical field can be used as appropriate. Specific examples of the lubricant (D) include a hydrocarbon-based lubricant, a fatty acid-based lubricant, a fatty acid amide-based lubricant, an ester-based lubricant, an alcohol-based lubricant, a metallic soap-based lubricant, silicone-based lubricants such as silicone oil and silicone gum, and an inorganic lubricant. However, the lubricant (D) is not limited to these examples.

Among these examples, a fatty acid amide-based lubricant is preferably used, and a higher fatty acid amide is particularly preferably used.

The fatty acid amide-based lubricant is not also particularly limited, and a conventionally known compound can be used.

The fatty acid that constitutes the fatty acid amide is preferably a higher fatty acid, and examples of the higher fatty acid include a fatty acid having 6 or more carbon atoms, preferably 12 or more carbon atoms, and preferably 24 or less carbon atoms (the number of carbon atoms means the number of carbon atoms of the higher fatty acid, and does not mean the number of carbon atoms of the whole of the fatty acid amide as the component (D), and the number of carbon atoms of, for example, a bis-fatty acid amide described later is about twice the number of carbon atoms described above).

The fatty acid amides may be used singly or in combination of two or more thereof.

Examples of a suitable fatty acid amide include a mono-fatty acid amide (D1) and a bis-fatty acid amide (D2).

The amount of the fatty acid amide-based lubricant is not particularly limited, but is preferably 0.05 parts by mass to 5 parts by mass, more preferably 0.24 parts by mass or more, further preferably 1.2 parts by mass or more, and more preferably 3.0 parts by mass or less, further preferably 1.8 parts by mass or less, relative to 100 parts by mass of the total of the components (A) to (C).

When being more than or equal to the above lower limit value, the amount of the fatty acid amide-based lubricant is preferred in terms of, for example, the objective of suppressing a peeling sound. When being less than or equal to the above upper limit value, the amount of the fatty acid amide-based lubricant is preferred in terms of, for example, suppressing poor appearance caused by bleed.

### Mono-Fatty Acid Amide (D1)

The mono-fatty acid amide (D1) only needs to be an amide formed of one fatty acid and one amine, and is not particularly subjected to any other limitations. The mono-fatty acid amide (D1) may be a saturated fatty acid amide or an unsaturated fatty acid amide.

Here, the saturated fatty acid that constitutes the mono-fatty acid amide (D1) is preferably a saturated fatty acid having 6 to 25 carbon atoms, and examples of such a saturated fatty acid include caproic acid, enanthic acid, caprylic acid, pelargonic acid, capric acid, lauric acid, myristic acid, pentadecylic acid, palmitic acid, margaric acid, stearic acid, arachidic acid, heneicosylic acid, behenic acid, and lignoceric acid.

The unsaturated fatty acid that constitutes the mono-fatty acid amide (D1) is preferably an unsaturated fatty acid having 6 to 25 carbon atoms, and examples of such an unsaturated fatty acid include erucic acid, oleic acid, myristoleic acid, palmitoleic acid, sapienic acid, vaccenic acid, gadoleic acid, eicosenoic acid, nervonic acid, linoleic acid, eicosadienoic acid, docosadienoic acid, linolenic acid, pinolenic acid, eleostearic acid, mead acid, dihomo-γ-linolenic acid, eicosatrienoic acid, stearidonic acid, arachidonic acid, eicosatetraenoic acid, adrenic acid, bosseopentaenoic acid, eicosapentaenoic acid, osbond acid, clupanodonic acid, tetracosapentaenoic acid, docosahexaenoic acid, nisinic acid, brassidic acid, elaidic acid, and ricinoleic acid.

Among the mono-fatty acid amides (D1) formed from these fatty acids, erucamide and oleamide are preferred, and erucamide is particularly preferred.

The amount of the mono-fatty acid amide (D1) is not particularly limited, but is preferably 0.05 parts by mass to 3 parts by mass, more preferably 0.08 parts by mass or more, further preferably 0.4 parts by mass or more, and more preferably 1.8 parts by mass or less, further preferably 0.6 parts by mass or less, relative to 100 parts by mass of the total of the components (A) to (C).

When being more than or equal to the above lower limit value, the amount of the mono-fatty acid amide (D1) is preferred in terms of, for example, the objective of suppressing a peeling sound. When being less than or equal to the above upper limit value, the amount of the mono-fatty acid amide (D1) is preferred in terms of, for example, suppressing poor appearance caused by bleed.

The molecular weight of the mono-fatty acid amide (D1) is not particularly limited, but is preferably 101 to 499, more preferably 201 to 449, further preferably 251 to 399. When being in this range, the molecular weight of the mono-fatty acid amide (D1) is preferred in terms of the objective of suppressing a peeling sound, and suppressing poor appearance caused by bleed.

### Bis-Fatty Acid Amide (D2)

The bis-fatty acid amide (D2) only needs to be an amide formed of two fatty acids and one diamine, and is not particularly subjected to any other limitations. The bis-fatty acid amide (D2) may be a bis-saturated fatty acid amide or a bis-unsaturated fatty acid amide.

Preferred examples of the bis-fatty acid amide (D2) include methylene bis-saturated fatty acid amide, methylene bis-unsaturated fatty acid amide, ethylene bis-saturated fatty acid amide, and ethylene bis-unsaturated fatty acid amide. Here, specific examples and the like of the saturated fatty acid and the unsaturated fatty acid that constitute the bis-fatty acid amide (D2) are the same as those described above regarding the mono-fatty acid amide (D1). The two fatty acids of the bis-fatty acid amide (D2) may be of one type, that is, two fatty acids of the identical type may be used, or two different types of fatty acids may be used in combination.

Among fatty acid amides, ethylene bisstearamide and ethylene bisoleamide are preferred, and ethylene bisstearamide is particularly preferred.

The amount of the bis-fatty acid amide (D2) is not particularly limited, but is preferably 0.05 parts by mass to 3 parts by mass, more preferably 0.16 parts by mass or more, further preferably 0.8 parts by mass or more, and more preferably 1.8 parts by mass or less, further preferably 1.2 parts by mass or less, relative to 100 parts by mass of the total of the components (A) to (C).

When being more than or equal to the above lower limit value, the amount of the bis-fatty acid amide (D2) is preferred in terms of, for example, the objective of suppressing a peeling sound. When being less than or equal to the above upper limit value, the amount of the bis-fatty acid amide (D2) is preferred in terms of, for example, suppressing poor appearance caused by bleed.

The molecular weight of the bis-fatty acid amide (D2) is not particularly limited, but is preferably 200 to 999, more preferably 450 to 849, further preferably 500 to 799. When being in this range, the molecular weight of the bis-fatty acid amide (D2) is preferred in terms of the objective of suppressing a peeling sound, and suppressing poor appearance caused by bleed.

As the lubricant (D), the mono-fatty acid amide (D1) and the bis-fatty acid amide (D2) are preferably used in combination. That is, the lubricant (D) preferably contains at least the mono-fatty acid amide (D1) and the bis-fatty acid amide (D2).

By using the mono-fatty acid amide (D1) and the bis-fatty acid amide (D2) in combination, the molded article according to the present embodiment can more effectively suppress a sound made when peeled from glass, and can have more excellent bondability to other members.

In the combination use of the mono-fatty acid amide (D1) and the bis-fatty acid amide (D2), the mass ratio mono-fatty acid amide (D1)/bis-fatty acid amide (D2) is not particularly limited, but is preferably in a range of 0.2 to 5, particularly preferably in a range of 0.2 to 1, further preferably in a range of 0.4 to 0.6.

By the mass ratio mono-fatty acid amide (D1)/bis-fatty acid amide (D2) being in the range of 0.2 to 5, the molded article according to the present embodiment can further effectively suppress a sound made when peeled from glass, and can have further excellent bondability to other members.

The mechanism is not altogether clear in which by using the mono-fatty acid amide (D1) and the bis-fatty acid amide (D2) in combination and setting the mass ratio mono-fatty acid amide (D1)/bis-fatty acid amide (D2) to the range of 0.2 to 5 in the present embodiment, the molded article can further effectively suppress a sound made when peeled from glass, and can have further excellent bondability to other members. However, the mechanism is presumed to have something to do with improvement of affinity of the mono-fatty acid amide (D1) for the surface of glass having many polar groups, via the bis-fatty acid amide (D2) having two amide groups.

### Mineral Oil (E)

The molded article according to the present invention may contain a mineral oil (E).

The mineral oil (E) may be mixed with the ethylene-based copolymer (A) or the copolymer (B) having a structural unit derived from an aromatic vinyl compound and a structural unit derived from a conjugated diene compound. That is, the ethylene-based copolymer (A) and/or the copolymer (B) having a structural unit derived from an aromatic vinyl compound and a structural unit derived from a conjugated diene compound may be extended with the mineral oil (E).

Examples of the mineral oil (E) preferably used as a softener in the present embodiment include high boiling-point fractions (average molecular weight: 300 to 1500, pour point: 0° C. or lower) of petroleum, such as an aromatic mineral oil, a naphthenic mineral oil, and a paraffinic mineral oil. Among these examples, a paraffinic mineral oil is preferred.

The mineral oil (E) is desired to be, as an extender oil, added to the ethylene-based copolymer (A), particularly to the ethylene-α-olefin-non-conjugated diene copolymer (A1), or to the copolymer (B) having a structural unit derived from an aromatic vinyl compound and a structural unit derived from a conjugated diene compound. The addition method may be a known method, and examples of the known method include (1) a method for mechanically kneading both materials using a kneader such as a roll and a Banbury mixer, and (2) a method for adding the component (E) to a component (A) or (B) solution into which the component (A) or (B) has been produced, and next subjecting the mixture to desolvation by a method such as steam stripping.

When the mineral oil (E) is blended as an extender oil of the ethylene-based copolymer (A) or the copolymer (B) having a structural unit derived from an aromatic vinyl compound and a structural unit derived from a conjugated diene compound, the composition (oil-extended polymer) made from the mineral oil (E), the ethylene-based copolymer (A) and/or the copolymer (B) having a structural unit derived from an aromatic vinyl compound and a structural unit derived from a conjugated diene compound has a Mooney viscosity (ML₁₊₄125° C.) measured at 125° C. of preferably 5 or more and 300 or less, more preferably 10 or more and 250 or less, further preferably 40 or more and 200 or less. The Mooney viscosity (ML₁₊₄125° C.) is measured in accordance with JIS K6300.

From the viewpoint of, for example, realizing the above Mooney viscosity, the addition amount of the mineral oil (E) is preferably 20 parts by mass to 80 parts by mass, more preferably 25 parts by mass to 70 parts by mass, further preferably 30 parts by mass to 60 parts by mass, relative to 100 parts by mass of the total amount of the ethylene-based copolymer (A) and/or the copolymer (B) having a structural unit derived from an aromatic vinyl compound and a structural unit derived from a conjugated diene compound, and the mineral oil (E).

### Crosslinker (F)

For the molded article according to the present invention, a thermoplastic elastomer composition having a sea-island structure is preferably formed. For this reason, the molded article is preferably produced through a step of melt-kneading, in the presence of a crosslinker (F), a mixture containing: the at least one component selected from the group consisting of the ethylene-based copolymer (A) and the copolymer (B) having a structural unit derived from an aromatic vinyl compound and a structural unit derived from a conjugated diene compound; the propylene-based polymer (C); and the lubricant (D).

As the crosslinker (F) preferably used in the present embodiment, a crosslinker that is normally used for crosslinking of rubber, and examples of such a crosslinker include an organic peroxide, a phenolic resin, sulfur, a sulfur-containing compound, p-quinone, a derivative of p-quinone dioxime, a bismaleimide compound, an epoxy compound, a silane compound, and an amino resin. Among these examples, an organic peroxide and a phenolic resin are preferred.

Examples of the organic peroxide include ketone peroxides, diacyl peroxides, hydroperoxides, dialkyl peroxides, peroxy ketals, alkyl peresters, percarbonates, peroxy dicarbonates, and peroxy esters.

Specific examples of the organic peroxide include dicumyl peroxide, 2,5-dimethyl-2,5-di(tert-butylperoxy)hexane, 2,5-dimethyl-2,5-di(tert-butylperoxy)hexyne, 1,3-bis(tert-butylperoxyisopropyl)benzene, tert-butylcumyl peroxide, di-tert-butyl peroxide, 2,2,4-trimethylpentyl-2-hydroperoxide, diisopropylbenzohydroperoxide, cumene peroxide, tert-butyl peroxide, 1,1-di(tert-butylperoxy)3,5,5-trimethylcyclohexane, 1,1-di-tert-butylperoxycylohexane, isobutyl peroxide, 2,4-dichlorobenzoyl peroxide, o-methylbenzoyl peroxide, bis-3,5,5-trimethylhexanoyl peroxide, lauroyl peroxide, benzoyl peroxide, and p-chlorobenzoyl peroxide.

The organic peroxides may be used singly, or two or more of the organic peroxides may be used.

The organic peroxide used in the present embodiment may have any of shapes such as a liquid, powder, and pellets. For good dispersibility, the organic peroxide is more preferably used by diluting with a diluent inert to the crosslinking reaction, such as an inorganic filler, a mineral oil, and a medium. As an addition method, the organic peroxide is more preferably added in a liquid state. Among diluents, a paraffinic oil is a preferred diluent in consideration of handleability and influences to the product.

In order to progress the crosslinking reaction uniformly and moderately, an organic peroxide and a crosslinking aid may be used in combination. As the crosslinking aid, a sulfur-based, methacrylate-based, or maleimide-based polyfunctional compound can be blended. Examples of the crosslinking aid include sulfur, p-quinone dioxime, p,p′-dibenzoylquinone dioxime, ethylene glycol dimethacrylate, diethylene glycol dimethacrylate, triethylene glycol dimethacrylate, tetraethylene glycol dimethacrylate, polyethylene glycol dimethacrylate, trimethylolpropane trimethacrylate, diallyl phthalate, tetraallyloxyethane, triallyl isocyanurate, N,N′-m-phenylene bismaleimide, maleic anhydride, divinylbenzene, zinc diacrylate, and zinc dimethacrylate. Among these examples, preferred is N,N′-m-phenylene bismaleimide, p,p′-dibenzoylquinone dioxime, divinylbenzene, trimethylolpropane trimethacrylate, or triallyl isocyanurate. N,N′-m-phenylene bismaleimide can be used singly also as a crosslinker.

Examples of the phenolic resin used as the crosslinker (F) include a compound generally used as a rubber crosslinker and represented by the following formula (see U.S. Pat. Nos. 3,287,440 and 3,709,840).

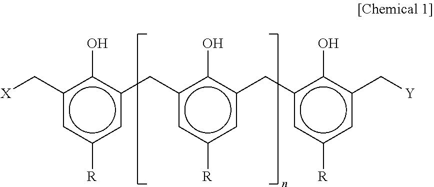

In the formula, n is an integer of 0 to 10; X and Y are each independently a hydroxy group, an alkyl halide group, or a halogen atom; and R is a saturated hydrocarbon group having 1 to 15 carbon atoms. The compound can be produced by condensation polymerization of a substituted phenol and an aldehyde with an alkaline catalyst.

Examples of the phenolic resin also include alkylphenol formaldehyde and brominated alkylphenol formaldehyde.

When used as the crosslinker, the phenolic resin may be used in combination with a crosslinking accelerator to adjust the speed of the crosslinking reaction. Examples of the crosslinking accelerator include metal halides such as stannous chloride and ferric chloride; and organic halides such as chlorinated polypropylene, a brominated butyl rubber, and a chloroprene rubber.

The phenolic resin is preferably used in combination with a metal oxide (for example, zinc oxide) and a dispersant such as stearic acid.

The addition amount of the crosslinker (F) is not particularly limited, and a person skilled in the art can set as appropriate the suitable addition amount of the crosslinker (F) to perform at a prescribed level the crosslinking of, for example, the ethylene-based copolymer (A) and the copolymer (B) having a structural unit derived from an aromatic vinyl compound and a structural unit derived from a conjugated diene compound.

The crosslinker (F) is sometimes decomposed in a process, such as melt-kneading, for crosslinking, for example, the ethylene-based copolymer (A) and the copolymer (B) having a structural unit derived from an aromatic vinyl compound and a structural unit derived from a conjugated diene compound. Therefore, the suitable amount of the crosslinker (F) is generally specified not by the amount of the crosslinker (F) remaining in the molded article according to the present invention, but by the amount of the crosslinker (F) before melt-kneading, in the presence of the crosslinker (F), the ethylene-based copolymer (A), the copolymer (B) having a structural unit derived from an aromatic vinyl compound and a structural unit derived from a conjugated diene compound, and the propylene-based polymer (C).

The amount of the crosslinker (F) before the melt-kneading is preferably 0.001 parts by mass or more and 3.0 parts by mass or less, more preferably 0.01 parts by mass or more and 2.0 parts by mass or less, further preferably 0.1 parts by mass or more and 1.0 part by mass or less, relative to 100 parts by mass of the total amount of the ethylene-based copolymer (A), the copolymer (B) having a structural unit derived from an aromatic vinyl compound and a structural unit derived from a conjugated diene compound, and the propylene-based polymer (C).

When the crosslinker (F) is used together with the crosslinking aid, the amount of the crosslinking aid before the melt-kneading is preferably 0.01 parts by mass or more and 10 parts by mass or less, more preferably 0.05 parts by mass or more and 1.0 parts by mass or less, relative to 100 parts by mass of the total amount of the ethylene-based copolymer (A), the copolymer (B) having a structural unit derived from an aromatic vinyl compound and a structural unit derived from a conjugated diene compound, and the propylene-based polymer (C).

### Other Components

The molded article according to the present invention may contain various additives other than the essential components, i.e., the at least one component selected from the group consisting of the ethylene-based copolymer (A) and the copolymer (B) having a structural unit derived from an aromatic vinyl compound and a structural unit derived from a conjugated diene compound, the propylene-based polymer (C), and the lubricant (D), and the preferred components, i.e., the mineral oil (E) and the crosslinker (F).

Examples of the additives include a polymer or oligomer other than the components (A) to (C), a softener other than the mineral oil (E), an inorganic filler (e.g., talc, calcium carbonate, sintered kaolin, glass fibers, hollow glass spheres, silica, metallic soap, titanium dioxide, mica, and potassium titanate fibers), an organic filler (e.g., fibers, wood powder, cellulose powder, carbon fibers, and carbon black), an antioxidant (e.g., phenol-based, sulfur-based, phosphorus-based, lactone-based, or vitamin-based), a weathering stabilizer, an ultraviolet absorber (e.g., benzotriazole-based, triazine-based, anilide-based, or benzophenone-based), a thermal stabilizer, a photostabilizer (e.g., hindered amine-based or benzoate-based), a pigment (e.g., an inorganic pigment, an organic pigment, and a pigment dispersant), a nucleating agent, a foaming agent, a foam nucleating agent, a plasticizer, a flame retardant, a brightening agent, an antibacterial agent, a light diffusing agent, an adsorbent (a metal oxide (e.g., zinc oxide and magnesium oxide)), a moisture dispersing agent, a VOC/odor stripping agent, a water storage agent (e.g., an aqueous medium containing an amphipathic polymer), a scratch resistance improver, and a metal chloride (e.g., iron chloride and calcium chloride), hydrotalcite, and an aluminate. These additives may be used singly or in combination of two or more thereof.

Examples of the resin other than the components (A) to (C) include an olefin-based resin (except those corresponding to the components (A) and (C)), an olefin-based elastomer (except those corresponding to the components (A) and (C)), a polyphenylene ether-based resin, a polyamide-based resin, a polyester-based resin, a polyoxymethylene-based resin, and a polymethyl methacrylate-based resin.

The thermoplastic elastomer molded article according to the present invention may be a molded article containing carbon-14 (14C) as a constituent element, and may be a molded article obtained through material recycle (mechanical recycle).

The concentration of carbon-14 (14C) contained in the thermoplastic elastomer molded article can be determined as pMC (percentage of modern carbon: unit %) by an AMS (Accelerator mass spectrometry) method specified in ISO 16620-2: 2019.

Carbon dioxide in the atmosphere contains carbon-14 (14C) at a certain proportion, and therefore, plants, for example, corn and wood, which grow by taking in carbon dioxide in the atmosphere are known to contain 14C. On the other hand, fossil resources, such as petroleum, which are considered to have been stored in the ground for a long period are known to hardly contain carbon-14 (14C). Accordingly, by using a substance derived from a plant as a raw material of a monomer of the components used to obtain the thermoplastic elastomer molded article, i.e., the ethylene-based copolymer (A), the copolymer (B) having a structural unit derived from an aromatic vinyl compound and a structural unit derived from a conjugated diene compound, the propylene-based polymer (C), and/or the mineral oil (E), it is possible to make the thermoplastic elastomer contain carbon-14 (14C) as a constituent element.

In the production of the components used to obtain the thermoplastic elastomer molded article, the ethylene-based copolymer (A), the copolymer (B) having a structural unit derived from an aromatic vinyl compound and a structural unit derived from a conjugated diene compound, the propylene-based polymer (C), and/or the mineral oil (E), it is possible to use, for example, a fossil resource-derived monomer (e.g., ethylene, propylene, 1-butene, and 1-hexene), a plant-derived monomer (e.g., ethylene, propylene, 1-butene, and 1-hexene), and a chemically recycled monomer (e.g., ethylene, propylene, 1-butene, and 1-hexene), and these monomers may be used in combination of two or more thereof.

Specific examples of the combination of monomers include fossil resource-derived ethylene/plant-derived ethylene/chemically recycled ethylene, fossil resource-derived propylene/plant-derived propylene/chemically recycled propylene, and fossil resource-derived propylene/plant-derived propylene/chemically recycled propylene/fossil-resource derived ethylene/plant-derived ethylene/chemically recycled ethylene.

The fossil resource-derived monomer is derived from carbon of underground resources such as petroleum, coal, and natural gas, and hardly contains carbon-14 (14C) in general. Examples of a method for producing the fossil resource-derived monomer include a known method such as a method for producing an olefin, for example, by cracking of petroleum-derived naphtha, ethane, or the like, or by dehydrogenation of ethane, propane, or the like

The plant-derived monomer is derived from carbon circulating as animals or plants on the ground, and generally contains carbon-14 (14C) at a certain level. Examples of a method for producing the plant-derived monomer include a known method such as cracking of bionaphtha, a plant oil, an animal oil, or the like, dehydrogenation of biopropane, a method for separating an alcohol from a fermented product of sugar or the like extracted from a plant raw material such as sugar cane and corn, and subjecting the resultant product to a dehydration reaction (JP-A-2010-511634, JP-A-2011-506628, JP-A-2013-503647, etc.), and a method for subjecting ethylene obtained from plant-derived ethanol, and n-butene to a metathesis reaction (WO 2007/055361, etc.).

The chemically recycled monomer is derived from carbon generated through decomposition or combustion of waste, and the amount of C-14 (14C) contained in the monomer is various depending on the waste. Examples of a method for producing the chemically recycled monomer include a known method such as a method for pyrolyzing waste plastic (JP-A-2017-512246, etc.), a method for cracking waste plant oil, waste animal oil, or the like (JP-A-2018-522087, etc.), and a method for subjecting waste, such as wet refuse, biomass waste, food waste, waste oil, waste wood, waste paper, and waste plastic, to gasification, alcohol conversion, and a dehydration reaction (JP-A-2019-167424, WO 2021/006245, etc.).

When two or more of a fossil resource-derived olefin, a plant-derived olefin, and a chemically recycled olefin are used, olefins that have each been individually produced may be used by mixing in a combination such as fossil resource-derived olefin/plant-derived olefin, fossil resource-derived olefin/chemically recycled olefin, plant-derived olefin/chemically recycled olefin, and fossil resource-derived olefin/plant-derived olefin/chemically recycled olefin. Alternatively, a mixture produced as any one of the combinations of olefins described above may be used by using, as a raw material or production intermediate in a step of producing an olefin, a mixture in a combination such as fossil resource-derived compound/plant-derived compound, fossil resource-derived compound/chemically recycled compound, plant-derived compound/chemically recycled compound, and fossil resource-derived compound/plant-derived compound/chemically recycled compound.

As the component (A), i.e., the ethylene-based copolymer, containing carbon-14 (14C), it is possible to use a commercially available ethylene copolymer, or an ethylene polymer containing more than 90 mass % of a monomer unit derived from ethylene. Examples of such an ethylene copolymer or polymer include “I'M GREEN” (green polyethylene) series manufactured by Braskem S. A, “TRUCIRCLE” series manufactured by SABIC, and “CirculenRenew” series manufactured by LyondellBasell Industries.

As the component (C), i.e., the propylene-based polymer, containing carbon-14 (14C), it is possible to use a commercially available propylene-based polymer. Examples of such a propylene-based polymer include “Bornewables” series manufactured by Borealis AG, “TRUCIRCLE” series manufactured by SABIC, and “CirculenRenew” series manufactured by LyondellBasell Industries.

From the viewpoint of reducing environmental burden, the concentration of carbon-14 (14C) of the thermoplastic elastomer molded article is preferably 0.2 pMC % or more, more preferably 0.5 pMC % or more, further preferably 1 pMC % or more, further more preferably 5 pMC % or more, particularly preferably 10 pMC % or more. From the viewpoint of costs, the concentration is preferably 99 pMC % or less, more preferably 95 pMC % or less, further preferably 90 pMC % or less, further more preferably 70 pMC % or less, particularly preferably 50 pMC % or less.

The concentration of carbon-14 (14C) of the thermoplastic elastomer molded article can be adjusted by changing the ratio between the fossil resource-derived olefin, the plant-derived olefin, and the chemically recycled olefin used in the production of the thermoplastic elastomer molded article.

### Molded Article

The molded article according to the present invention only needs to contain the at least one component selected from the group consisting of the ethylene-based copolymer (A) and the copolymer (B) having a structural unit derived from an aromatic vinyl compound and a structural unit derived from a conjugated diene compound, the propylene-based polymer (C), and the lubricant (D), and the blending amounts of the components are not particularly limited, but the molded article preferably contains, relative to 100 parts by mass of the total of the components (A) to (C), 40 parts by mass to 85 parts by mass of the total of the ethylene-based copolymer (A) and/or the copolymer (B) having a structural unit derived from an aromatic vinyl compound and a structural unit derived from a conjugated diene compound, and 15 parts by mass to 60 parts by mass of the propylene-based polymer (C).

The amount of the ethylene-based copolymer (A) and/or the copolymer (B) having a structural unit derived from an aromatic vinyl compound and a structural unit derived from a conjugated diene compound is more preferably 50 mass % to 90 mass % in total, particularly preferably 55 mass % to 85 mass % in total.

The amount of the propylene-based polymer (C) is more preferably 10 mass % to 50 mass %, particularly preferably 15 mass % to 45 mass %. By the blending described above, the molded article according to the present embodiment can further improve various types of performance such as suppression of a sound made when the molded article peeled from glass, and bondability to other members.

The molded article according to the present invention has a flexural modulus measured at room temperature in accordance with JIS K7171 of 20 MPa or more and 300 MPa or less.

By having a flexural modulus in the above range, and also satisfying the other requirements of the present invention, the molded article according to the present invention can realize technical effects such as flexibility and shape retainability.

More specifically, the molded article preferably has a flexural modulus of 20 MPa or more from the viewpoint of shape retainability and the like.

From these viewpoints, the molded article according to the present invention has a flexural modulus of preferably 40 MPa or more, more preferably 50 MPa or more.

More specifically, the molded article preferably has a flexural modulus of 300 MPa or less from the viewpoint of flexibility and the like.

From these viewpoints, the molded article according to the present invention has a flexural modulus of preferably 200 MPa or less, more preferably 100 MPa or less.

The flexural modulus of the molded article can be measured in accordance with JIS K7171, more specifically in accordance with, for example, a method described in Examples of the present application.

The flexural modulus of the molded article can be adjusted as appropriate, for example, by selecting and adjusting the materials and/or the blending amounts of the components, particularly the components (A) to (C), constituting the molded article, by adjusting the degree of crosslinking when the crosslinker (F) is used, or by changing the conditions of melt-kneading.

The molded article according to the present invention has a shear strength against a float glass plate measured under specific conditions of 40 N/cm² or less, more specifically the shear strength being measured by disposing, on a flat plate, two test pieces cut out from the molded article according to the present invention and having a length of 50 mm, a width of 6 mm, and a thickness of 2 mm, such that a gap between opposite 50 mm×2 mm surfaces of the two test pieces is 60 mm, fixing 50 mm×6 mm surfaces of the two test pieces onto the flat plate, bringing other 50 mm×6 mm surfaces of the two test pieces into direct contact with a 110 mm×110 mm surface of a float glass plate having a length of 110 mm, a width of 110, and a thickness of 3 mm in accordance with JIS R 3202, leaving the two test pieces and the float glass plate to stand still at 80° C. for 50 hours, and then subjecting an interlayer between the two test pieces and the float glass plate to tension at 200 mm/min in a shear direction and a longitudinal (50 mm) direction of the two test pieces.

By having a shear strength against a float glass plate measured under the specific conditions of 40 N/cm² or less, and also satisfying the other conditions of the present invention, the molded article according to the present invention can realize practically highly valuable and remarkable technical effects such as effective suppression of a sound made when the molded article peeled from glass, and excellent bondability to other members.

The mechanism of realizing the technical effects by the molded article having a shear strength against a float glass plate measured under the specific conditions of 40 N/cm² or less is not altogether clear. However, the shear strength of the molded article against glass and the sound made when the molded article is peeled from glass are properties that can be affected by the interfacial state between the glass and the molded article, and therefore, the mechanism is presumed to have something to do with, for example, a possibility in which the interfacial state that can effectively suppress the peeling sound is indirectly evaluated by the shear strength.

The molded article has a shear strength against a float glass plate measured under the specific conditions of preferably 30 N/cm² or less, particularly preferably 14 N/cm² or less, further preferably 9 N/cm² or less.

There is no particular lower limit of the shear strength against a float glass plate measured under the specific conditions, but the lower limit is preferably 0.1 N/cm² or more, particularly preferably 1 N/cm² or more, from the viewpoint of, for example, adhesiveness to glass.

The shear strength against a float glass plate can be measured by the method described above, more specifically by a method described in Examples of the present application.

The shear strength of the molded article according to the present invention against a float glass plate measured under the specific conditions can be adjusted as appropriate by selecting and adjusting the materials, the blending amounts, and the like of the components, particularly the lubricant (D) and the other components, constituting the molded article. Examples of a particularly effective adjusting means include: using, as the lubricant (D), the mono-fatty acid amide (D1) and the bis-fatty acid amide (D2), and adjusting the mass ratio therebetween; and increasing the amount of the propylene-based polymer (C).

The molded article according to the present invention preferably has a melt viscosity measured at a temperature of 220° C. and a shear rate of 12 sec-1 of 2500 Pa·sec or less.

By having a melt viscosity of 2500 Pa·sec or less, the molded article according to the present embodiment has high flowability in the molding such as injection molding performed in a molding process, and has excellent moldability, good molded-article appearance such as surface smoothness, and excellent bondability to other members.

The melt viscosity can be measured by melting the molded article at a prescribed temperature and performing melt viscosity measurement at a prescribed shear rate in accordance with a method known in this technical field.

The melt viscosity can be increased or decreased as appropriate by adjusting the content proportion and the melt flow rate of the propylene-based polymer (C) contained in the molded article; the proportion and the particle diameter of the island phase of the sea-island structure which is normally formed of the ethylene-based copolymer (A) and/or the copolymer (B) having a structural unit derived from an aromatic vinyl compound and a structural unit derived from a conjugated diene compound; and the gel fraction and the like.

The method for producing the molded article according to the present invention is not particularly limited, and the molded article can be produced by kneading, by an ordinary method, a mixture of the raw materials thereof, i.e., the at least one component selected from the group consisting of the ethylene-based copolymer (A) and the copolymer (B) having a structural unit derived from an aromatic vinyl compound and a structural unit derived from a conjugated diene compound, the propylene-based polymer (C), and the lubricant (D), and various additives added as desired, using a normal extruder, a Banbury mixer, a roll, a Brabender plastograph, a Kneader brabender, or the like. The molded article is preferably produced by melt-kneading using an extruder, particularly a twin-screw extruder. All the components to be kneaded may collectively be melt-kneaded, or the melt-kneading may be performed by kneading a part of the components, and then adding the rest of the components thereto, and the melt-kneading may be performed once or twice or more. The melt-kneading temperature is preferably 150° C. to 300° C., more preferably 180° C. to 250° C. The melt-kneading time is preferably 20 seconds to 30 minutes, more preferably 30 seconds to 20 minutes. The components to be kneaded may be added in any order or simultaneously.

In the production of the molded article according to the present invention, crosslinking may be performed, or the molded article may be non-crosslinked. From the viewpoint of, for example, a control of the sea-island structure and the melt viscosity, crosslinking is preferably performed.

In a preferred production method including performing crosslinking, a step is preferably performed in which a mixture containing the at least one component selected from the group consisting of the ethylene-based copolymer (A) and the copolymer (B) having a structural unit derived from an aromatic vinyl compound and a structural unit derived from a conjugated diene compound, the propylene-based polymer (C), and the lubricant (D) is melt-kneaded in the presence of the crosslinker (F).

When the ethylene-based copolymer (A) is used, it is preferred that the ethylene-based copolymer (A) has a Mooney viscosity (ML₁₊₄125° C.) of 40 or more and the propylene-based polymer (C) has a melt flow rate measured under the conditions of a temperature of 230° C. and a load of 21.18 N of 0.3 g/10 min to 200 g/10 min.

When the ethylene-based copolymer (A) is extended with the mineral oil (E), a step is preferably performed in which an oil-extended polymer made from the mineral oil (E) and the ethylene-based copolymer (A), the propylene-based polymer (C), and the lubricant (D) are melt-knead in the presence of the crosslinker (F). It is preferred that the oil-extended polymer preferably has a Mooney viscosity (ML₁₊₄125° C.) of 40 or more and the propylene-based polymer (C) has a melt flow rate measured under the conditions of a temperature of 230° C. and a load of 21.18 N of 0.3 g/10 min to 200 g/10 min.

The molded article according to the present invention is preferably used for various uses for which thermoplastic elastomers have conventionally and suitably been used. The molded article is preferably used particularly for various members and a part or the whole of a product that are produced by injection molding or extrusion molding.

The use of the molded article according to the present invention can give an extrusion-molded article or injection-molded article having good surface smoothness. Therefore, the molded article can particularly preferably be used for uses in which smooth molded-product appearance is required.

The surface smoothness can be evaluated, for example, by measuring ten-point average roughness on the surface of the molded article.

Further, the molded article according to the present invention has excellent bondability to other members, particularly to a member formed of a thermoplastic elastomer composition containing a propylene-based polymer for the sea phase. Therefore, the molded article can particularly preferably be used to produce a composite molded product including such a member.

More specifically, examples of preferred uses of the molded article according to the present invention include, in addition to various vehicle interior and exterior components such as a glass run channel, a weather strip, a door grommet, an instrument panel, a glove compartment, trims, housings, a pillar, a bumper, a fender, and a back door, various components of electric household appliances, various household equipment components, various industrial components, and various building material components. However, the uses are not limited to these examples.

An injection-molded article as a preferred embodiment of the present invention can be produced by subjecting a thermoplastic elastomer composition having substantially the same blending as the molded article according to the present invention, for example, to a normal injection molding method, or, as necessary, to any one of various molding methods such as a gas injection molding method, an injection compression molding method, and a short-shot foam molding method. The molding conditions of the injection molding are not particularly limited, but the injection molding can be performed at a molding temperature of generally 100° C. to 300° C., preferably 180° C. to 280° C., an injection pressure of 5 MPa to 100 MPa, preferably 10 MPa to 80 MPa, and a mold temperature of 20° C. to 80° C., preferably 20° C. to 60° C.

The injection-molded article as a preferred embodiment of the present invention may be formed as a composite molded article by bonding to another member, making use of the excellent bondability of the injection-molded article. Examples of the other member included in the composite molded article include an extrusion-molded article containing a thermoplastic elastomer composition or a vulcanized rubber composition. Preferably used is a molded article containing a thermoplastic elastomer composition having the same type of blending as the molded article according to the present invention, particularly a molded article that contains a thermoplastic elastomer composition containing a propylene-based polymer as the sea phase of the sea-island structure. To such another member, the injection-molded article as a preferred embodiment can realize further excellent bondability.

The injection-molded article according to this embodiment has a bond strength to another member of preferably 3.0 MPa or more, more preferably 3.3 MPa or more, particularly preferably 3.5 MPa or more.

A higher bond strength to another member is more preferred, and the upper limit of the bond strength is not particularly limited. However, when a composite molded product is produced at practical costs, the injection-molded article has normally a bond strength of 6.0 MPa or less in many cases.

In the production of the composite molded article according to the present embodiment, a composite molded article is preferably produced by disposing another member such as an extrusion-molded article in a mold, and next injection-molding into the mold a thermoplastic elastomer composition having the same composition as the molded article according to the present invention to bond the molded article according to the present invention to the other member. For example, a glass run channel having, for example, excellent appearance and bond strength between a main part and a corner part can be produced by disposing, as the extrusion-molded article, a main part (linear part) of the glass run channel in a mold for injection molding, and next forming the molded article according to the present invention by injection molding to form a corner part bonded to the main part.

The molded article according to the present invention can effectively suppress a sound made when peeled from glass. Therefore, when the molded article is used for a glass run channel, a noise generated when glass is raised or lowered can be suppressed.

### EXAMPLES

Hereinafter, the present invention is in further detail described by way of examples. However, the present invention is not to be limited to these examples.

The physical properties and characteristics in examples and comparative examples were evaluated by the following methods.

### 1. Method for Producing Injection-Molded Article

A thermoplastic elastomer composition produced in examples and comparative examples was injection-molded into an injection-molded article having a length of 150 mm, a width of 90 mm, and a thickness of 2.0 mm, using injection-molding machine IS100EN-3A manufactured by Toshiba Machine Co., Ltd., under the conditions of a molding temperature of 220° C. and a mold temperature of 50° C.

### 2. Stiffness (Flexural Modulus)

The flexural modulus of the injection-molded article produced in 1. above was, in accordance with JIS K7171, measured in a standard atmosphere of 23° C./50% RH and at a test rate of 1 mm/min.

### 3. Evaluation of Bondability to Thermoplastic Elastomer Molded Article

A thermoplastic elastomer molded article (Y) obtained in [Reference Example 1] described later was used as a material to be bonded. First, the thermoplastic elastomer molded article (Y) was placed in a mold for injection molding.

Then, the thermoplastic elastomer composition produced in each of the examples and the comparative examples was injection-molded, using injection-molding machine IS100EN-3A manufactured by Toshiba Machine Co., Ltd., under the conditions of a molding temperature of 250° C. and a mold temperature of 50° C., into a composite molded article (Z1) in which the thermoplastic elastomer molded article (Y) and an injection-molded article part made from the thermoplastic elastomer composition obtained in each of the examples and the comparative examples were melt-bonded to each other.

A test piece was prepared by punching the molded article (Z1) into dumb-bell No. 3 described in JIS K6251 such that the test piece included a melt-bonded surface perpendicular to the longitudinal direction of the test piece. The test piece was subjected to a tensile test under the conditions of a tensile rate of 200 mm/min and a standard atmosphere of 23° C./50% RH, and had the bond strength thereof evaluated.

### Reference Example 1

### (Preparation of Thermoplastic Elastomer Molded Article (Y))

Thermoplastic elastomer “SANTOPRENE 121-73W175” manufactured by Exxon Mobil Corporation was injection-molded into an injection-molded article (length: 150 mm, width: 90 mm, thickness: 2.0 mm), using injection-molding machine IS100EN-3A manufactured by Toshiba Machine Co., Ltd., under the conditions of a molding temperature of 220° C., a mold temperature of 50° C., an injection time of 10 seconds, and a cooling time of 30 seconds. Next, the injection-molded article was cut with a cutter into a piece having a length of 30 mm, a width of 90 mm, and a thickness of 2.0 mm, and the piece was used as the thermoplastic elastomer molded article (Y).

### 4. Shear Strength Against Glass

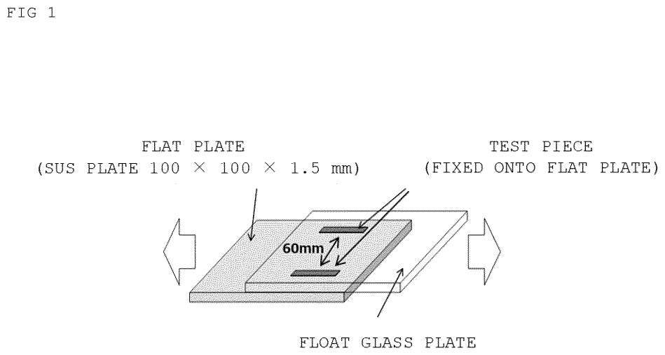

Two test pieces having a length of 50 mm and a width of 6 mm were punched out from a press sheet (thickness 2 mm) obtained by press-molding the thermoplastic elastomer composition produced in the examples and the comparative examples described later under the following molding conditions, the test pieces were disposed in parallel on a SUS plate having a length of 100 mm, a width of 100 mm, and a thickness of 1.5 mm, such that a gap between opposite 50 mm×2 mm surfaces of the test pieces was 60 mm, and the test pieces had 50 mm×6 mm surfaces thereof attached to the SUS plate with double sided tape. On the other 50 mm×6 mm surfaces of these test pieces, a float glass plate having a length of 110 mm, a width of 110 mm, and a thickness of 3.0 mm in accordance with JIS R 3202 was placed, left in an oven set to 80° C., and after a lapse of 50 hours, air-cooled in a standard atmosphere of 23° C./50% RH for 12 hours. A tensile test was performed by pulling the float glass plate in the longitudinal direction of the test pieces under the conditions of 200 mm/min and 23° C./50% RH, and the shear strength was evaluated (FIG. 1).
Molding conditions: The press sheet was prepared by sandwiching the thermoplastic elastomer composition with polyester films, followed by hot press molding at a temperature of 200° C. and a maximum pressure of 10 MPa for 5 minutes, and then cold press molding at a temperature of 23° C. and a maximum pressure of 10 MPa for 5 minutes.
   5. Sound Made when Molded Article Peeled from Glass

In the test of 4. above, a measurer evaluated, at a position about 30 cm away from the test pieces, the existence or non-existence of a sound made when the test pieces were peeled from the float glass plate, by the average value of two measurements using the following 5-point scale. The difference between the two measured values was 0.4 in average, which indicated that the measured values were reliable.
1: A sound made at the time of peeling is very loudly heard.
2: A sound made at the time of peeling is loudly heard.
3: A sound made at the time of peeling is slightly heard.
4: A sound made at the time of peeling is very slightly heard.
5: No sound is heard at the time of peeling.

The details of the materials used in the examples and the comparative examples are described below.

### <Component (A)> Ethylene-Based Copolymer (A1-i)+(E)

Oil-extended ethylene-propylene-5-ethylidene-2-norbornene copolymer (mixture of 100 parts by mass of component (A2-i) and 100 parts by mass of component (E))
Mooney viscosity (ML₁₊₄125° C.) of (A1-i)+(E)=47
Mooney viscosity (ML₁₊₄125° C.) of (A1-i) calculated by the equation (1)=215

### Composition of (A1-i)

Proportion of constitutional unit derived from ethylene=70.0 mass %
Proportion of constitutional unit derived from propylene=21.5 mass %
Proportion of constitutional unit derived from 5-ethylidene-2-norbornene=8.5 mass %
   <Component (B)> Copolymer Having Structural Unit Derived from Aromatic Vinyl Compound and Structural Unit Derived from Conjugated Diene Compound
(B-i): Trade name “TAIPOL (registered trademark) 6151” manufactured by TSRC Corporation, proportion of monomer unit derived from styrene=32.5 mass %, weight-average molecular weight in terms of polystyrene=240,000

### <Component (C)> Propylene-Based Polymer

(C1-i): Propylene homopolymer, trade name “Sumitomo NOBLEN D101” manufactured by SUMITOMO CHEMICAL COMPANY, LIMITED, MFR (230° C., 21.18 N)=0.5 g/10 min
(C1-ii): Propylene homopolymer, trade name “Sumitomo NOBLEN R101” manufactured by SUMITOMO CHEMICAL COMPANY, LIMITED, MFR (230° C., 21.18 N)=20 g/10 min

### <Component (D)> Lubricant

(D1-i): Erucamide, trade name “NEUTRON S” manufactured by NIPPON FINE CHEMICAL CO., LTD., molecular weight=338
(D2-i): Ethylene bisstearamide, trade name “ALFLOW H-50P” manufactured by NOF CORPORATION, molecular weight=593

### <Component (F)> Crosslinker

(F-i)+(E-i): Mixture of 10 mass % of component (F-i) and 90 mass % of component (E-i) (when the total amount of (F-i) and (E-i) is defined as 100 wt %)
(F-i): 2,5-Dimethyl-2,5-di(t-butylperoxy)hexane, trade name “APO-10DL” manufactured by Kayaku Akuzo Kabushiki Kaisha

### <Component (E)> Mineral Oil

(E-i): Paraffinic mineral oil, trade name “PW-100” manufactured by Idemitsu Kosan Co., Ltd., pour point=−12.5° C.
Crosslinking aid: N,N′-m-phenylene bismaleimide, trade name “Sumifine BM” manufactured by SUMITOMO CHEMICAL COMPANY, LIMITED
Antioxidant: Trade name “IRGANOX (registered trademark) 1010” manufactured by BASF Japan Ltd.
Black pigment masterbatch: Trade name “PEM8080G” manufactured by SUMIKA COLOR CO., LTD.

### Example 1

A thermoplastic elastomer composition was obtained by melt-kneading 75.0 parts by mass of the oil-extended ethylene random copolymer ((A2-i)+(F)), 20.0 parts by mass of the propylene homopolymer (C-i), 0.125 parts by mass of the fatty acid amide (D-i), 0.2 parts by mass of the fatty acid amide (D-ii), 3 parts by mass of the crosslinker ((E-i)+(F-i)), 0.1 parts by mass of the crosslinking aid, 0.2 parts by mass of the antioxidant, and 1.2 parts by mass of the pigment at a cylinder temperature of 200° C.±20° C. in an upstream step of a twin-screw extruder (TEX34αIII) manufactured by The Japan Steel Works, Ltd., and melt-kneading 5 parts by mass of the propylene homopolymer (C-i) at a cylinder temperature of 200° C.±20° C. in a downstream step of the twin-screw extruder. The resultant thermoplastic elastomer composition was injection-molded, by the method 1. or 3. above, or press-molded by the method 4. above, into a molded article. Table 1 shows measurement results of the physical properties of the molded article, and an evaluation result of bondability to the thermoplastic elastomer molded article.

### Examples 2 to 5 and Comparative Examples 1 and 2

A thermoplastic elastomer molded article was produced and evaluated in the same manner as in Example 1 except that the blending of the raw materials was changed as shown in Table 1.

Table 1 shows the results.

TABLE 1

| | | | | Exam- | Exam- | Exam- | Exam- | Exam- | Comparative | Comparative |
|---|---|---|---|---|---|---|---|---|---|---|
| Step | Composition | | | ple 1 | ple 2 | ple 3 | ple 4 | ple 5 | Example 1 | Example 2 |
| Upstream step | Component (A) + | (A1-i) + (E) | — | 75 | 75 | 75 | 75 | — | 75 | 75 |
| | Component (E) | EPDM (100 parts | | | | | | | | |
| | | oil-extended) | | | | | | | | |
| | Component (B) | SEBS (B-i) | Taipol 6151 | — | — | — | — | 33 | — | — |
| | Component (C) | h-PP (C1-i) | D101 | 20 | 20 | 20 | 20 | — | 20 | 20 |
| | | h-PP (C1-ii) | R101 | — | — | — | — | 22 | — | — |
| | Component (D1) | Mono-fatty acid | Erucamide | 0.125 | 0.5 | 0.5 | 1.5 | 0.5 | 0.5 | — |
| | | amide (D1-i) | | | | | | | | |
| | Component (D2 | Bis-fatty acid | Ethylene | 0.2 | 1.0 | 2.0 | 2.0 | 1.0 | — | 1.0 |
| | | amide (D2-i) | bisstearamide | | | | | | | |
| | Mineral oil (E-i) | | PW100 | — | — | — | — | 45 | — | — |
| | Crosslinker (F-i) | | APO-10DL | 3.0 | 3.0 | 3.0 | 3.0 | — | 3.0 | 3.0 |
| | Crosslinking aid | | Sumifine BM | 0.1 | 0.1 | 0.1 | 0.1 | — | 0.1 | 0.1 |
| | Antioxidant | | Irganox 1010 | 0.2 | 0.2 | 0.2 | 0.2 | 0.2 | 0.2 | 0.2 |
| | Black pigment | | PEM8080G | 1.2 | 1.2 | 1.2 | 1.2 | 1.2 | 1.2 | 1.2 |
| Downstream step | Component (C) | h-PP (C1-i) | D101 | 5.0 | 5.0 | 5.0 | 5.0 | — | 5.0 | 5.0 |

| | | | | | | | | |
|---|---|---|---|---|---|---|---|---|
| Blending-amount ratio of lubricants (D1)/(D2) | — | 0.63 | 0.50 | 0.25 | 0.75 | 0.50 | — | — |
| Flexural modulus | MPa | 81 | 76 | 89 | 88 | 46 | 71 | 74 |
| Shear strength (against glass) | N/cm² | 34 | 14 | 16 | 15 | 4 | 43 | >60 |
| Bond strength (against TPV) | MPa | 3.6 | 3.4 | 3.5 | 3.4 | 3.5 | 3.4 | 3.4 |
| Sound made when molded article peeled from glass | Good 5-1 Poor | 3 | 5 | 4 | 4 | 5 | 2 | 1 |

In the table, the blending amounts of the components are represented by parts by mass unless otherwise specified.

The thermoplastic elastomer molded article according to the present invention can effectively suppress a sound made when peeled from glass, and has excellent bondability to other members. Therefore, the thermoplastic elastomer molded article is suitably used for uses including, in addition to various vehicle interior and exterior components such as a glass run channel, a weather strip, a door grommet, an instrument panel, a glove compartment, trims, housings, a pillar, a bumper, a fender, and a back door, various components of electric household appliances, various household equipment components, various industrial components, and various building material components. The thermoplastic elastomer molded article is thus highly usable in industrial fields such as a transport machinery industry, an electric and electronic industry, and a building and construction industry.

1. A molded article comprising: at least one component selected from the group consisting of an ethylene-based copolymer (A) and a copolymer (B) having a structural unit derived from an aromatic vinyl compound and a structural unit derived from a conjugated diene compound; a propylene-based polymer (C); and a lubricant (D),
the molded article having a flexural modulus measured at room temperature in accordance with JIS K7171 of 20 MPa or more and 300 MPa or less, and
the molded article having a shear strength of 40 N/cm² or less, the shear strength being measured by disposing, on a flat plate, two test pieces cut out from the molded article and having a length of 50 mm, a width of 6 mm, and a thickness of 2 mm, such that a gap between opposite 50 mm×2 mm surfaces of the two test pieces is 60 mm, fixing 50 mm×6 mm surfaces of the two test pieces onto the flat plate, bringing other 50 mm×6 mm surfaces of the two test pieces into direct contact with a 110 mm×110 mm surface of a float glass plate having a length of 110 mm, a width of 110 mm, and a thickness of 3 mm in accordance with JIS R 3202, leaving the two test pieces and the float glass plate to stand still at 80° C. for 50 hours, and then subjecting an interlayer between the two test pieces and the float glass plate to tension at 200 mm/min in a shear direction and a longitudinal direction of the two test pieces.

2. The molded article according to claim 1, comprising the ethylene-based copolymer (A).

3. The molded article according to claim 2, further comprising a mineral oil (E).

4. The molded article according to claim 3, wherein the ethylene-based copolymer (A) is extended with the mineral oil (E).

5. The molded article according to claim 1, comprising the copolymer (B) having a structural unit derived from an aromatic vinyl compound and a structural unit derived from a conjugated diene compound.

6. The molded article according to claim 5, further comprising a mineral oil (E).

7. The molded article according to claim 1, wherein the lubricant (D) contains at least a mono-fatty acid amide (D1) and a bis-fatty acid amide (D2), and a mass ratio mono-fatty acid amide (D1)/bis-fatty acid amide (D2) is in a range of 0.2 to 5.

8. The molded article according to claim 7, wherein the mass ratio mono-fatty acid amide (D1)/bis-fatty acid amide (D2) is in a range of 0.2 to 1.

9. The molded article according to claim 7, wherein the mono-fatty acid amide (D1) is erucamide.

10. The molded article according to claim 7, wherein the bis-fatty acid amide (D2) is ethylene bisstearamide.

11. A method for producing the molded article according to claim 1, the method comprising: a step of melt-kneading, in the presence of a crosslinker (F), a mixture containing: the at least one component selected from the group consisting of the ethylene-based copolymer (A) and the copolymer (B) having a structural unit derived from an aromatic vinyl compound and a structural unit derived from a conjugated diene compound; the propylene-based polymer (C); and the lubricant (D).

12. The molded article according to claim 1, being an injection-molded article.

13. A composite molded article obtained by bonding the injection-molded article according to claim 12 to an extrusion-molded article containing a thermoplastic elastomer composition or a vulcanized rubber composition.

14. The composite molded article according to claim 13, being a glass run channel.
